(19) United States
(12) Patent Application Publication
(10) Pub. No.: US 2026/0281418 A1
(43) Pub. Date: Sep. 17, 2026

(54) METHOD AND APPARATUS OF REGION-BASED MULTIPLE-PASS DMVR FOR VIDEO CODING

(71) Applicant: MEDIATEK INC., Hsinchu City (TW)

(72) Inventors: Chen-Yen LAI, Hsinchu City (TW); Guan-Hao CHEN, Hsinchu City (TW); Wen-Chun LIN, Hsinchu City (TW); Tzu-Der CHUANG, Hsinchu City (TW); Chih-Wei HSU, Hsinchu City (TW); Ching-Yeh CHEN, Hsinchu City (TW)

(21) Appl. No.: 19/472,688

(22) PCT Filed: Aug. 1, 2024
(86) PCT No.: PCT/CN2024/109133

§ 371 Date: Oct. 5, 2025

Related U.S. Application Data
(60) Provisional application No. 63/530,573, filed on Aug. 3, 2023.

(51) Int. Cl. H04N 19/513; H04N 19/119; H04N 19/137; H04N 19/176; H04N 19/70

(52) U.S. Cl. CPC H04N 19/513; H04N 19/119; H04N 19/137; H04N 19/176; H04N 19/70

(57) ABSTRACT

Method and apparatus of motion vector refinement using MP-DMVR or BDOF. A current block is divided into N sub-regions, where N is a positive integer. A subblock size is determined for each of the N sub-regions according to predicted samples in said each of the N sub-regions. Said each of the N sub-regions is partitioned into one or more subblocks according to the subblock size determined. DMVR (Decoder-Side Motion Vector Refinement) or BDOF (Bi-directional Optical Flow) is applied to said one or more subblocks in said each of the N sub-regions.

### CROSS REFERENCE TO RELATED APPLICATIONS

The present invention claims priority to U.S. Provisional Patent Application, Ser. No. 63/530,573, filed on Aug. 3, 2023. The U.S. Provisional patent application is hereby incorporated by reference in its entirety.

### FIELD OF THE INVENTION

The present invention relates to bi-directional prediction for MV refinement based on Multi-Pass Decoder-Side Motion Vector Refinement (MP-DMVR) or BDOF (Bi-Directional Optical Flow).

### BACKGROUND AND RELATED ART

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology-Coded representation of immersive media-Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction 110, the prediction data is derived based on previously coded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, is provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

According to VVC, an input picture is partitioned into non-overlapped square block regions referred as CTUs (Coding Tree Units), similar to HEVC. Each CTU can be partitioned into one or multiple smaller size coding units (CUs). The resulting CU partitions can be in square or rectangular shapes. Also, VVC divides a CTU into prediction units (PUs) as a unit to apply prediction process, such as Inter prediction, Intra prediction, etc.

The VVC standard incorporates various new coding tools to further improve the coding efficiency over the HEVC standard. Furthermore, various new coding tools (for example, Decoder-Side Motion Vector Refinement (DMVR), Bi-directional Optical Flow (BDOF), and some other coding tools) have been proposed for consideration in the development of a new coding standard beyond the VVC.

### Multi-Pass Decoder-Side Motion Vector Refinement (MP-DMVR)

In ECM-2.0, a Multi-Pass (MP) DMVR method is applied in regular merge mode if the selected merge candidate meets the DMVR conditions. In the first pass, bilateral matching (BM) is applied to the coding block. In the second pass, BM is applied to each 16×16 subblock within the coding block. In the third pass, MV in each 8×8 subblock is refined by applying bi-directional optical flow (BDOF).

Similar to the DMVR in VVC, the BM refined a pair of motion vectors MV0 and MV1 under the constrain that MVD0 (MV0′-MV0) is just the opposite sign of MVD1 (MV1′-MV1), as in FIG. 2.

In order to increase the accuracy of the MVs of the merge mode, a bilateral-matching (BM) based decoder side motion vector refinement is applied in VVC. In bi-prediction operation, a refined MV is searched around the initial MVs (232 and 234) in the reference picture list L0 212 and reference picture list L1 214 for a current block 220 the current picture 210. The collocated blocks 222 and 224 in L0 and L1 are determined according to the initial MVs 230 and 232) and the location of the current block 220 in the current picture as shown in FIG. 2. The BM method calculates the distortion between the two candidate blocks (242 and 244) in the reference picture list L0 and list L1. The locations of the two candidate blocks (242 and 244) are determined by adding two opposite offset (262 and 264) to the two initial MVs (232 and 234) to derive the two candidate MVs (252 and 254). The SAD between the candidate blocks (242 and 244) based on each MV candidate around the initial MV (232 or 234) is calculated. The MV candidate (252 or 254) with the lowest SAD becomes the refined MV and used to generate the bi-predicted signal.

### Adaptive Decoder Side Motion Vector Refinement (Adaptive MP-DMVR)

In JVET-X0049 (Han Huang, et al., “EE2: Adaptive decoder side motion vector refinement (test 3.4)”, in Joint Video Exploration Team (JVET) of ITU-T SG 16 WP 3 and ISO/IEC JTC 1/SC 29/WG 11, 24th Meeting, by teleconference, 6-15 Oct. 2021, Document: JVET-X0049), adaptive decoder side motion vector refinement is disclosed. The adaptive decoder side motion vector refinement method consists of two new merge modes introduced to refine MV only in one direction, either L0 or L1, of the bi-prediction for the merge candidates that meet the DMVR conditions. The multi-pass DMVR process is applied for the selected merge candidate to refine the motion vectors, however either MVD0 or MVD1 is set to zero in the first pass (i.e. PU level) DMVR.

Like the regular merge mode, merge candidates for the proposed merge modes are derived from the spatial neighboring coded blocks, TMVPs (Temporal Motion Vector Predictions), non-adjacent blocks, HMVPs (History-based Motion Vector Predictions), and pair-wise candidate. The difference is that only those meet DMVR conditions are added into the candidate list. The same merge candidate list is used by the two proposed merge modes and merge index is coded as in regular merge mode. There are two syntax elements to indicate this mode, including bmMergeFlag and bmDirFlag. bmMergeFlag is used to indicate the on-off of this kind of prediction (refine MV only on one direction). bmDirFlag is used to indicate the refined MV direction. For example, when bmDirFlag is equal to 0, the refined MV is from List0. When bmDirFlag is equal to 1, the refined MV is from List1. The syntax structure is shown in the following table.

TABLE 1
Syntax structure for bmMergeFlag and bmDirFlag

bm_merge_flag
if (bm_merge_flag)
bm_dir_flag

After decoding bm_merge_flag and bm_dir_flag, bmDir can be decided. For example, if bm_merge_flag is equal to 1 and bm_dir_flag is equal to 0, bmDir will be set as 1. Also, bmDir is used to represent the adaptive MP-DMVR and only refine the MV in List0. For another example, if bm_merge_flag is equal to 1 and bm_dir_flag is equal to 1, bmDir will be set as 2. Also, it is used to represent the adaptive MP-DMVR and only refine the MV in List1.

### Bi-Directional Optical Flow (BIO)/BDOF

Bi-directional optical flow (BIO or BDOF) is motion estimation/compensation technique disclosed in JCTVC-C204 (E. Alshina, et al., Bi-directional optical flow, Joint Collaborative Team on Video Coding (JCT-VC) of ITU-T SG 16 WP 3 and ISO/IEC JTC 1/SC 29/WG 11, 3rd Meeting: Guangzhou, CN, 7-15 Oct. 2010, Document: JCTVC-C204) and VCEG-AZ05 (E. Alshina, et al., Known tools performance investigation for next generation video coding, ITU-T SG 16 Question 6, Video Coding Experts Group (VCEG), 52^{nd} Meeting: 19-26 Jun. 2015, Warsaw, Poland, Document: VCEG-AZ05). BIO derived the sample-level motion refinement based on the assumptions of optical flow and steady motion as shown in FIG. 3, where a current pixel 322 in a B-slice (bi-prediction slice) 320 is predicted by one pixel (332) in reference picture 0 (330) and one pixel (312) in reference picture 1 (310). As shown in FIG. 3, the current pixel 322 is predicted by pixel B 312 in reference picture 1 (310) and pixel A 332 in reference picture 0 (330). In FIG. 3, vₓ and v_{y} are pixel displacement vector in the x-direction and y-direction, which are derived using a bi-directional optical flow (BIO) model. It is applied only for truly bi-directional predicted blocks, which is predicted from two reference pictures corresponding to the previous picture and the latter picture. In VCEG-AZ05, BIO utilizes a 5×5 window to derive the motion refinement of each sample. Therefore, for an N×N block, the motion compensated results and corresponding gradient information of an (N+4)×(N+4) block are required to derive the sample-based motion refinement for the N×N block. According to VCEG-AZ05, a 6-Tap gradient filter and a 6-Tap interpolation filter are used to generate the gradient information for BIO. Therefore, the computational complexity of BIO is much higher than that of traditional bi-directional prediction. In order to further improve the performance of BIO, the following methods are proposed.

In a conventional bi-prediction in HEVC, the predictor is generated using equation (1), where P⁽⁰⁾ and P⁽¹⁾ are the list0 and list1 predictor, respectively.

$${P}_{Conventional} [ i , j ] = ( {P}^{( 0 )} [ i , j ] + {P}^{( 1 )} [ i , j ] + 1 ) >> 1 \qquad ( 1 )$$

In JCTVC-C204 and VECG-AZ05, the BIO predictor is generated using equation (2).

$${P}_{OpticalFlow} = ( {P}^{( 0 )} [ i , j ] + {P}^{( 1 )} [ i , j ] + {v}_{x} [ i , j ] ( {I}_{x}^{( 0 )} - {I}_{x}^{( 1 )} [ i , j ] ) + {v}_{y} [ i , j ] ( {I}_{y}^{( 0 )} - {I}_{y}^{( 1 )} [ i , j ] ) + 1 ) >> 1 \qquad ( 2 )$$

In equation (2),

$${I}_{x}^{( 0 )} and {I}_{x}^{( 1 )}$$

represent the x-directional gradient in list0 and list1 predictor, respectively;

$${I}_{y}^{( 0 )} and {I}_{y}^{( 1 )}$$

represent the y-directional gradient in list0 and list1 predictor, respectively; vₓ and v_{y} represent the offsets or displacements in x- and y-direction, respectively. The derivation process of vₓ and v_{y} is shown in the following. First, the cost function is defined as diffCost(x, y) to find the best values vₓ and v_{y}. In order to find the best values vₓ and v_{y} to minimize the cost function, diffCost(x, y), one 5×5 window is used. The solutions of vₓ and v_{y} can be represented by using S₁, S₂, S₃, S₅, and S₆.

$$\begin{matrix}diffCost ( x , y ) = {\sum }_{Ω} ( {P}^{0} ( x , y ) + {v}_{x} \frac{\partial {P}^{0} ( x , y )}{\partial x} + {v}_{y} \frac{\partial {P}^{0} ( x , y )}{\partial y} - \\ {( {P}^{1} ( x , y ) - {v}_{x} \frac{\partial {P}^{1} ( x , y )}{\partial x} - {v}_{y} \frac{\partial {P}^{1} ( x , y )}{\partial y} ) )}^{2} , \\ = {\sum }_{Ω} ( {P}^{0} ( x , y ) - {P}^{1} ( x , y ) + {v}_{x} ( \frac{\partial {P}^{0} ( x , y )}{\partial x} + \frac{\partial {P}^{1} ( x , y )}{\partial x} ) + \\ {{v}_{y} ( \frac{\partial {P}^{0} ( x , y )}{\partial y} + \frac{\partial {P}^{1} ( x , y )}{\partial y} ) )}^{2} .\end{matrix} \qquad ( 3 )$$

The minimum cost function, min diffCost(x, y) can be derived according to:

$$\frac{\partial diffCost ( x , y )}{\partial {v}_{x}} = 0 , \frac{\partial diffCost ( x , y )}{\partial {v}_{y}} = 0. \qquad ( 4 )$$

By solving equations (3) and (4), vₓ and v_{y} can be solved according to eqn. (5):

$${v}_{x} = \frac{{S}_{3} {S}_{5} - {S}_{2} {S}_{6}}{{S}_{1} {S}_{5} - {S}_{2} {S}_{2}} , {v}_{y} = \frac{{S}_{1} {S}_{6} - {S}_{3} {S}_{2}}{{S}_{1} {S}_{5} - {S}_{2} {S}_{2}} \qquad ( 5 )$$

$$where ,$$

$${S}_{1} = {\sum }_{Ω} {( \frac{\partial {P}^{0} ( x , y )}{\partial x} + \frac{\partial {P}^{1} ( x , y )}{\partial x} )}^{2} ,$$

$${S}_{2} = {\sum }_{Ω} ( \frac{\partial {P}^{0} ( x , y )}{\partial x} + \frac{\partial {P}^{1} ( x , y )}{\partial x} ) ( \frac{\partial {P}^{0} ( x , y )}{\partial y} + \frac{\partial {P}^{1} ( x , y )}{\partial y} )$$

$${S}_{3} = - {\sum }_{Ω} ( \frac{\partial {P}^{0} ( x , y )}{\partial x} + \frac{\partial {P}^{1} ( x , y )}{\partial x} ) ( {P}^{0} ( x , y ) - {P}^{1} ( x , y ) ) ,$$

$${S}_{5} = {\sum }_{Ω} {( \frac{\partial {P}^{0} ( x , y )}{\partial y} + \frac{\partial {P}^{1} ( x , y )}{\partial y} )}^{2}$$

$${S}_{6} = - {\sum }_{Ω} ( \frac{\partial {P}^{0} ( x , y )}{\partial y} + \frac{\partial {P}^{1} ( x , y )}{\partial y} ) ( {P}^{0} ( x , y ) - {P}^{1} ( x , y ) ) .$$

We can find that the required bitdepth is large in BIO process, especially for calculating S₁, S₂, S₃, S₅, and S₆. For example, if the bitdepth of pixel value in video sequences is 10 bits and the bitdepth of gradients is increased by fractional interpolation filter or gradient filter, then 16 bits are required to represent one x-directional gradient or one y-directional gradient. These 16 bits may be further reduced by gradient shift equal to 4, so one gradient needs 12 bits to represent the value. Even if the magnitude of gradient can be reduced to 12 bits by gradient shift, the required bitdepth of BIO operations is still large. One multiplier with 13 bits by 13 bits is required to calculate S₁, S₂, and S₅, and another multiplier with 13 bits by 17 bits is required to get S₃, and S₆. When the window size is large, more than 32 bits may be required to represent S₁, S₂, S₃, S₅, and S₆.

In the present invention, methods to improve the coding efficiency related to MP-DMVR and BDOF are disclosed.

### BRIEF SUMMARY OF THE INVENTION

Method and apparatus of motion vector refinement using bi-directional prediction are disclosed. According to one method of the present invention, input data associated with a current block is received, wherein the input data comprise pixel data for the current block to be encoded at an encoder side or coded data associated with the current block to be decoded at a decoder side. The current block is divided into N sub-regions, wherein N is a positive integer. A subblock size is determined for each of the N sub-regions according to predicted samples in said each of the N sub-regions. Said each of the N sub-regions is partitioned into one or more subblocks according to the subblock size determined. DMVR (Decoder-Side Motion Vector Refinement) or BDOF (Bi-directional Optical Flow) is applied to said one or more subblocks in said each of the N sub-regions.

In one embodiment, the subblock size for said each of the N sub-regions is determined according to a first sum of x-gradients of predicted samples in an L0 reference block, a second sum of y-gradients of the predicted samples in the L0 reference block, a third sum of x-gradients of predicted samples in an L1 reference block, a fourth sum of y-gradients of the predicted samples in the L1 reference block, or a combination thereof. In another embodiment, the subblock size for said each of the N sub-regions is determined according to one or more ratios of a maximum value to a minimum value for x-gradients of predicted samples in an L0 reference block, y-gradients of the predicted samples in the L0 reference block, the x-gradients of predicted samples in an L1 reference block, and the y-gradients of the predicted samples in the L1 reference block. In one embodiment, said one or more ratios of the maximum value to the minimum value derived for a current region are referenced to determine the subblock size for MP (Multi-Pass)-DMVR or BDOF MV refinement of a following region.

In one embodiment, the subblock size for said each of the N sub-regions is determined according to a sum of differences between L0 predictor and L1 predictor. In one embodiment, said differences between L0 predictor and L1 predictor derived for a current region are referenced to determine the subblock size for MP (Multi-Pass)-DMVR or BDOF MV refinement of a following region.

In one embodiment, a control flag is signalled or parsed to indicate whether to enable said partitioning the current block into the N sub-regions, said determining the subblock size for said each of the N sub-regions according to the predicted samples in said each of the N sub-regions, said partitioning said each of the N sub-regions into said one or more subblocks according to the subblock size determined, and said applying the DMVR or BDOF to said one or more subblocks in said each of the N sub-regions. In one embodiment, the control flag is signalled or parsed at CU level, slice level, picture level, and/or sequence level.

According to another method of the present invention, input data associated with a current block is received, wherein the input data comprise pixel data for the current block to be encoded at an encoder side or coded data associated with the current block to be decoded at a decoder side. The current block is divided into N regions, wherein N is a positive integer. N motion vectors are derived for the N regions respectively. The N motion vectors are refined to derive N best refined motion vectors. Further motion vector refinement is applied for the current block in a subsequent pass by using information comprising the N best refined motion vectors.

In one embodiment, the N regions correspond to N non-overlapped sub-search regions. In another embodiment, the N regions correspond to N arbitrary-shaped regions.

In one embodiment, a target best refined motion vector is derived by searching around an initial motion vector in a target region of the N regions based on a minimum bilateral matching cost between two reference blocks in L0 and L1 reference pictures. In one embodiment, a candidate list including N best refined motion vectors of N regions is generated with similarity check to ensure that no best refined motion vectors in the candidate list are the same. In one embodiment, an index is signalled or parsed to indicate a target best refined motion vector in the candidate list, and further motion vector refinement is applied on the target best refined motion vector.

### BRIEF DESCRIPTION OF THE DRAWINGS

FIG. 1A illustrates an exemplary adaptive Inter/Intra video coding system incorporating loop processing.

FIG. 1B illustrates a corresponding decoder for the encoder in FIG. 1A.

FIG. 2 illustrates the process of Adaptive Decoder-side Motion Vector Refinement (Adaptive DMVR.

FIG. 3 illustrates the process of Bi-directional optical flow (BIO) or Bi-Directional Optical Flow (BDOF).

FIGS. 4A-C illustrate examples of non-overlapped sub-search regions including an original search region (FIG. 4A), four quadrants (FIG. 4B) and a checkerboard pattern (FIG. 4C).

FIG. 5 illustrates an example of a k×k square search pattern with step size=m, where k=5 and m=2.

FIG. 6 illustrates an exemplary flowchart of a video coding system using adaptive subblock size to refine motion vectors for individual subblocks according to an embodiment of the present invention.

FIG. 7 illustrates an exemplary flowchart of a video coding system using region-based approach to refine motion vectors for individual sub-search regions according to an embodiment of the present invention.

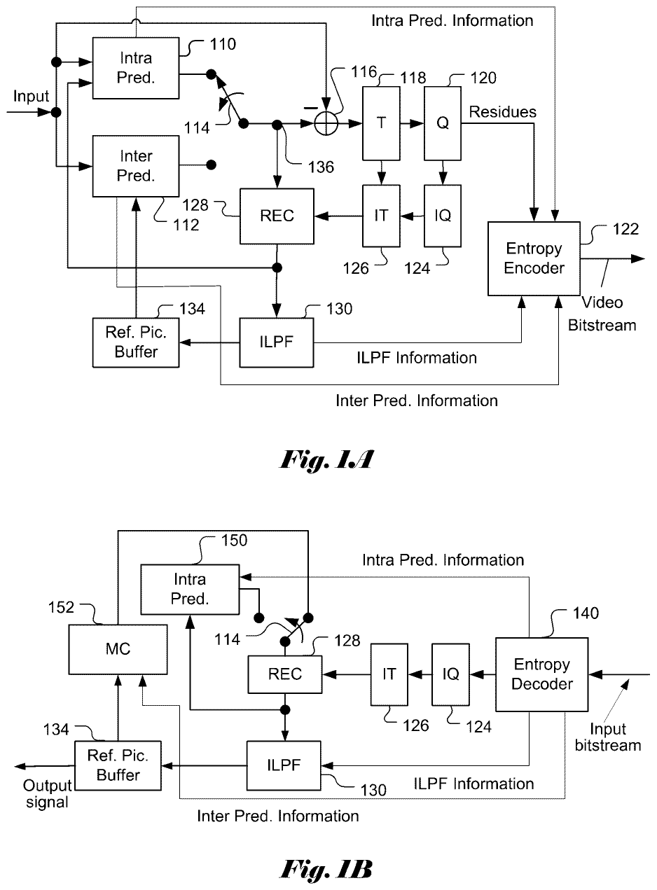

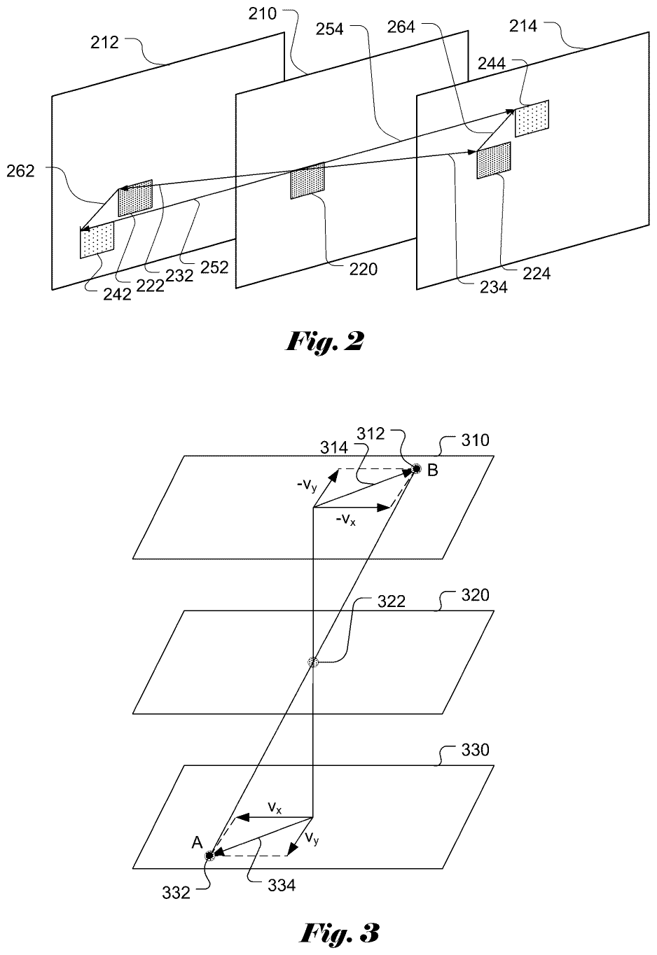

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

### Scheme 1: Increasing Operation Accuracy

In one embodiment, a CU can be partitioned into N sub-regions and each sub-region can be applied with different subblock size for MP-DMVR pass 3 or BDOF MV refinement. N can be any integer larger than 0. For example, N is a power-of-2 integer.

In one embodiment, sums of gradX0, gradY0, gradX1, and gradY1 can be referenced to determine an adaptive subblock size for MP-DMVR pass 3 or BDOF MV refinement.

In one embodiment, ratios of maximum and minimum value within gradX0, gradY0, gradX1, and gradY1 can be referenced to determine an adaptive subblock size for MP-DMVR pass 3 or BDOF MV refinement.

In one embodiment, a sum of predictor differences can be referenced to determine an adaptive subblock size for MP-DMVR pass 3 or BDOF MV refinement. The predictor differences refer to the differences between L0 predictor and L1 predictor.

In one embodiment, ratios of maximum and minimum value of gradX0, gradY0, gradX1, gradY1 or predictor differences of the first region can be referenced to determine an adaptive subblock size for MP-DMVR pass 3 or BDOF MV refinement of the second region. The first region may correspond to a region being processed currently and the second region may correspond to a region processed after the first region.

For example, a 16×16 is partitioned into 4 first region (with size 4×16), gradX0 of every sample in each 4×16 is accumulated respectively. After that, the maximum sum_gradX0 within four 4×16 region is determined. Also, the minimum sum_gradX0 within four 4×16 region. If sum_gradX0_maximum/sum_gradX0_minimum is larger than T, this 16×16 will be partitioned into 4×4 subblock for MP-DMVR pass 3 or BDOF MV refinement. T can be a threshold value associated with current block size.

In one embodiment, the above-mentioned methods can be combined with each other to determine final subblock size for MP-DMVR pass 3 or BDOF MV refinement.

In another embodiment, one on/off control flag is signalled at CU level, slice level, picture level, and/or sequence level to indicate the proposed method in the above is enabled or not.

In another embodiment, the proposed method in the above can be enabled or disabled according to one or a combination of the selected reference pictures indices, temporal distance between reference picture and current picture, quantization parameter, the coded information of current CU, prediction mode, motion vectors, motion vector resolution, residual of current CU, and reference samples.

### Scheme 2: Different Initial Lists for Adaptive DMVR Mode

Adaptive DMVR mode includes two types. First (L0 BM mode), the derived motion displacements are used to refine L0 only. Second (L1 BM mode), the derived motion displacements are used to refine L1 only.

In one embodiment, two merge lists can be used for two adaptive DMVR modes (BM mode) respectively.

In one embodiment, the BCW weight is considered in merge list generation. The candidates for L0 BM mode (the mode only refines motions in L0) shall have larger BCW weightings on L0 than L1.

In one embodiment, the BCW weight is considered in merge list generation. The candidates for L0 BM mode (the mode only refines motions in L0) shall have larger BCW weightings on L1 than L0.

In one embodiment, the POC distances between two reference pictures and the current picture are used in merge list generation. The to-be inserted candidates for the merge list of L0 BM mode (the mode only refines motions in L0) need to satisfy the following condition. That is, the POC distance of reference picture L0 and current picture shall be larger than the POC distance of reference picture L1 and current picture.

In one embodiment, the POC distances between two reference pictures and the current picture are used in merge list generation. The to-be inserted candidates for the merge list of L0 BM mode (the mode only refines motions in L0) need to satisfy the following condition. That is, the POC distance of reference picture L0 and the current picture shall be smaller than the POC distance of reference picture L1 and the current picture.

In another embodiment, one on/off control flag is signalled at CU level, slice level, picture level, and/or sequence level to indicate whether the proposed method in the above is enabled or not.

In another embodiment, the proposed method in the above is enabled or disabled, according to one or a combination of the selected reference pictures indices, temporal distance between reference picture and current picture, quantization parameter, the coded information of current CU, prediction mode, motion vectors, motion vector resolution, residual of current CU, and reference samples.

### Scheme 3: More BM Modes

In one embodiment, a combined mode is added to the merge mode.

In one embodiment, the combined candidate comprises the first refined L0 motion of L0 BM mode, and the second refined L1 motion of L1 BM mode. They are combined as a bi-prediction motion as the third motion candidate. Furthermore, the third motion candidate will be further refined by MP-DMVR process.

In one embodiment, MP-DMVR pass 1 (i.e., block-based BM refinement) is used to generate the first refined L0 motion and the second refined L1 motion.

In one embodiment, TM refinement is used to generate the first refined L0 motion and the second refined L1 motion.

In one embodiment, the third motion candidate is further refined by MP-DMVR pass 2 (i.e., subblock-based BM refinement).

In one embodiment, the third motion candidate is further refined by MP-DMVR pass 3 (i.e., BDOF related refinement).

In one embodiment, the third motion candidate is further refined by subblock-based BM refinement and BDOF refinement.

In one embodiment, the third motion candidate is further refined by TM.

In one embodiment, the first L0 motion can be an un-refined motion and the second L1 motion is a refined motion.

In one embodiment, MP-DMVR pass 1 (i.e., block-based BM refinement) can be used to refine motions on only L0, L1 or on both sides.

In one embodiment, TM refinement can be used to generate the refined motion.

In one embodiment, a flag is signalled at CU-level to indicate the on-off of the combined mode.

In one embodiment, if merge flag is enabled, the on-off flag of combined mode is signalled.

In one embodiment, if the combined mode is enabled, adaptive BM mode will be disabled.

In one embodiment, a first flag is signalled at CU-level to indicate the on-off of the combined mode. After that, a second flag is signalled at CU-level to indicate the mode type of adaptive BM mode and combined mode. Different context coded tables are used for adaptive BM mode and combined mode.

In one embodiment, more than one combined candidate (i.e., combining the first refined L0 motion of L0 BM mode, and the second refined L1 motion of L1 BM mode) are included in a merge candidate list. In that, the best one is determined by RD cost and a related index is signalled in the bitstream.

In another embodiment, one on/off control flag is signalled at CU level, slice level, picture level, and/or sequence level to indicate the proposed method in the above is enabled or not.

In another embodiment, the proposed method in the above is enabled or disabled, according to one or a combination of the selected reference pictures indices, temporal distance between the reference picture and the current picture, quantization parameter, the coded information of the current CU, prediction mode, motion vectors, motion vector resolution, residual of the current CU, and reference samples.

### Scheme 4: Additional Stage of MP-DMVR

In one embodiment, two subblock-based BM refinement can be performed iteratively.

In one embodiment, different subblock sizes can be used in different iterations. However, a same subblock size can also be used in different iterations.

In one embodiment, different searching algorithms can be used in different iterations to determine the final motion refinement of each subblock. However, a same searching algorithm can also be used in different iterations.

In one embodiment, in the first subblock based MP-DMVR, a bi-template bilateral matching searching is performed to refine the motions. In the second subblock based MP-DMVR, a bilateral matching searching is performed to refine the motions.

In one embodiment, for each subblock, after the first bilateral matching searching is performed, the first BM cost is calculated. Only if the first BM cost is larger than a threshold, the second subblock based BM searching will be performed.

In one embodiment, for each subblock, after the first bilateral matching searching is performed, the first BM cost is calculated. Only if the first BM cost multiplied by K is larger than a threshold, the second subblock based BM searching will be performed. K is a value larger than 0.

In another embodiment, one on/off control flag is signalled at CU level, slice level, picture level, and/or sequence level to indicate whether the proposed method as described above is enabled or not.

In another embodiment, the proposed method as described above is enabled or disabled according to one or a combination of the selected reference picture indices, temporal distance between the reference picture and the current picture, quantization parameter, the coded information of the current CU, prediction mode, motion vectors, motion vector resolution, residual of current CU, and reference samples.

### Scheme 5: Region-Based MP-DMVR

In one embodiment, N best refined motions are derived after MP-DMVR pass 1, and they will be further refined by pass 2 and pass 3. An index is signalled in the bitstream to indicate which one of the N refined motions is selected.

In one embodiment, N best refined motions can be derived by different search regions.

For example, the original search region is divided into N non-overlapped sub-search regions. For each sub-search region, the best refined motion is derived around the initiate MV based on the minimum bilateral matching cost between the two reference blocks in L0 and L1.

For another example, the original search region is divided into N arbitrarily sub-search regions. For each sub-search region, the best refined motion is derived according to the smallest bilateral matching cost. Furthermore, similarity check is applied to the best refined motion to guarantee that the refined motions derived from individual sub-search regions are not the same.

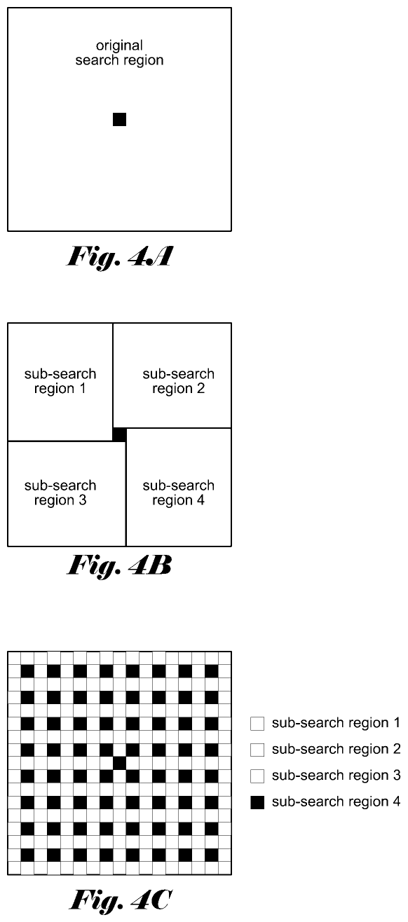

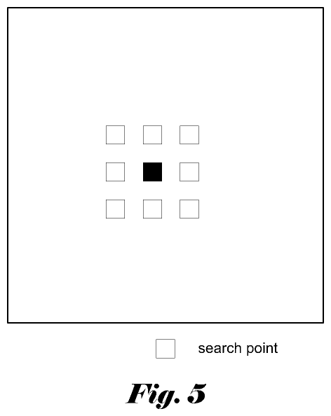

FIGS. 4A-C illustrate examples of non-overlapped sub-search regions with N=4. An original search region is shown in FIG. 4A. An example of dividing the search region into four quadrants is shown in FIG. 4B. An example of dividing the search region into a checkerboard pattern, where the samples shown in a same colour belong to a same sub-search region as shown in FIG. 4C.

In one embodiment, N best refined motions can be derived by different starting points.

For example, N different starting points in the search range are assigned. For each starting point, the best refined motion is derived based on the smallest bilateral matching cost and satisfying the similarity check.

In one embodiment, N best refined motions can be derived using different local search patterns.

For example, a local search is applied to a k×k square search pattern with step size=m as shown in FIG. 5 to loop through the search range, where k and m are positive integers. When the cost of bilateral matching at the centre point of the k×k square search pattern has the minimum cost, the local search is terminated. Otherwise, the current minimum cost search point becomes the new centre point of the k×k square search and continue to search for the minimum cost, until it reaches the end of the search range.

The description in the above is an example. The search pattern can be arbitrary shape.

In one embodiment, N best refined motions can be derived by combining above methods.

In another embodiment, one on/off control flag is signalled at CU level, slice level, picture level, and/or sequence level to indicate the proposed method in the above is enabled or not.

In another embodiment, the proposed method in the above is enabled or disabled, according to one or a combination of the selected reference pictures indices, temporal distance between the reference picture and the current picture, quantization parameter, the coded information of the current CU, prediction mode, motion vectors, motion vector resolution, residual of current CU, and reference samples.

Any of the foregoing proposed methods of adaptive subblock size for motion vector refinement and/or region-based MP-DMVR can be implemented in encoders and/or decoders. For example, any of the proposed methods can be implemented in MP-DMVR module and/or BDOF module of an encoder and/or a decoder, where the MP-DMVR and/or BDOF module can be a module inside the motion estimation or motion compensation unit. Alternatively, any of the proposed methods can be implemented as a circuit coupled to MP-DMVR module of the encoder and/or the decoder.

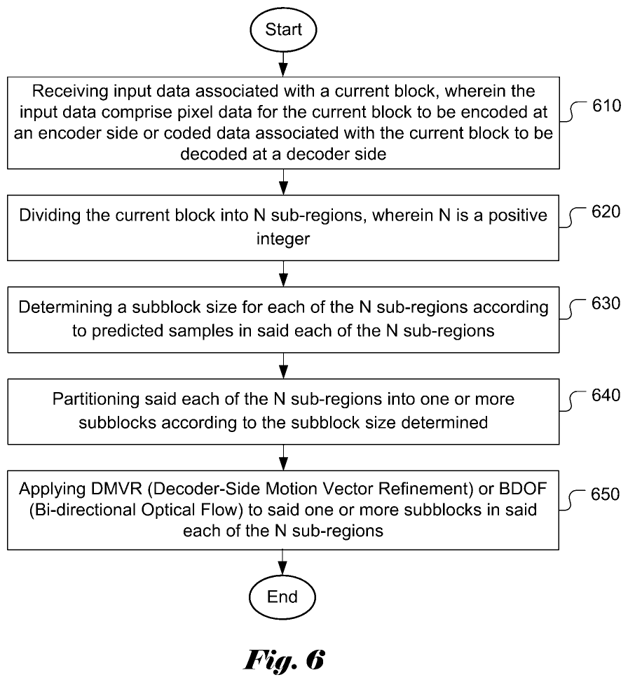

FIG. 6 illustrates an exemplary flowchart of a video coding system using adaptive subblock size to refine motion vectors for individual subblocks according to an embodiment of the present invention. The steps shown in the flowchart, as well as other flowcharts in this disclosure, may be implemented as program codes executable on one or more processors (e.g., one or more CPUs) at the encoder side and/or the decoder side. The steps shown in the flowchart may also be implemented based on hardware such as one or more electronic devices or processors arranged to perform the steps in the flowchart. According to this method, input data associated with a current block is received in step 610, wherein the input data comprise pixel data for the current block to be encoded at an encoder side or coded data associated with the current block to be decoded at a decoder side. The current block is divided into N sub-regions in step 620, wherein N is a positive integer. A subblock size is determined for each of the N sub-regions according to predicted samples in said each of the N sub-regions in step 630. Said each of the N sub-regions is partitioned into one or more subblocks according to the subblock size determined in step 640. DMVR (Decoder-Side Motion Vector Refinement) or BDOF (Bi-directional Optical Flow) is applied to said one or more subblocks in said each of the N sub-regions in step 610.

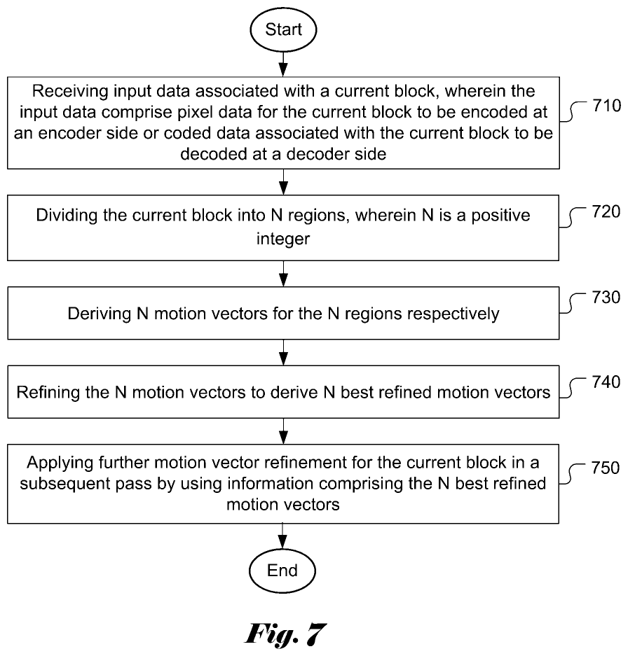

FIG. 7 illustrates an exemplary flowchart of a video coding system using region-based approach to refine motion vectors for individual sub-search regions according to this embodiment of the present invention. According to this embodiment, input data associated with a current block is received in step 710, wherein the input data comprise pixel data for the current block to be encoded at an encoder side or coded data associated with the current block to be decoded at a decoder side. The current block is divided into N regions in step 720, wherein N is a positive integer. N motion vectors are derived for the N regions respectively in step 730. The N motion vectors are refined to derive N best refined motion vectors in step 740. Further motion vector refinement is applied for the current block in a subsequent pass by using information comprising the N best refined motion vectors.

The flowcharts shown above are intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding, the method comprising:
receiving input data associated with a current block, wherein the input data comprise pixel data for the current block to be encoded at an encoder side or coded data associated with the current block to be decoded at a decoder side;
dividing the current block into N sub-regions, wherein N is a positive integer;
determining a subblock size for each of the N sub-regions according to predicted samples in said each of the N sub-regions;
partitioning said each of the N sub-regions into one or more subblocks according to the subblock size determined; and
applying DMVR (Decoder-Side Motion Vector Refinement) or BDOF (Bi-directional Optical Flow) to said one or more subblocks in said each of the N sub-regions.

2. The method of claim 1, wherein the subblock size for said each of the N sub-regions is determined according to a first sum of x-gradients of predicted samples in an L0 reference block, a second sum of y-gradients of the predicted samples in the L0 reference block, a third sum of x-gradients of predicted samples in an L1 reference block, a fourth sum of y-gradients of the predicted samples in the L1 reference block, or a combination thereof.

3. The method of claim 1, wherein the subblock size for said each of the N sub-regions is determined according to one or more ratios of a maximum value to a minimum value for x-gradients of predicted samples in an L0 reference block, y-gradients of the predicted samples in the L0 reference block, the x-gradients of predicted samples in an L1 reference block, and the y-gradients of the predicted samples in the L1 reference block.

4. The method of claim 3, wherein said one or more ratios of the maximum value to the minimum value derived for a current region are referenced to determine the subblock size for MP (Multi-Pass)-DMVR or BDOF MV refinement of a following region.

5. The method of claim 1, wherein the subblock size for said each of the N sub-regions is determined according to a sum of differences between L0 predictor and L1 predictor.

6. The method of claim 5, wherein said differences between L0 predictor and L1 predictor derived for a current region are referenced to determine the subblock size for MP (Multi-Pass)-DMVR or BDOF MV refinement of a following region.

7. The method of claim 1, wherein a control flag is signalled or parsed to indicate whether to enable said partitioning the current block into the N sub-regions, said determining the subblock size for said each of the N sub-regions according to the predicted samples in said each of the N sub-regions, said partitioning said each of the N sub-regions into said one or more subblocks according to the subblock size determined, and said applying the DMVR or BDOF to said one or more subblocks in said each of the N sub-regions.

8. The method of claim 7, wherein the control flag is signalled or parsed at CU level, slice level, picture level, and/or sequence level.

9. An apparatus for video coding, the apparatus comprising one or more electronics or processors arranged to:
receive input data associated with a current block, wherein the input data comprise pixel data for the current block to be encoded at an encoder side or coded data associated with the current block to be decoded at a decoder side;
divide the current block into N sub-regions, wherein N is a positive integer;
determine a subblock size for each of the N sub-regions according to predicted samples in said each of the N sub-regions;
partition said each of the N sub-regions into one or more subblocks according to the subblock size determined; and
apply DMVR (Decoder-Side Motion Vector Refinement) or BDOF (Bi-directional Optical Flow) to said one or more subblocks in said each of the N sub-regions.

10. A method of video coding, the method comprising:
receiving input data associated with a current block, wherein the input data comprise pixel data for the current block to be encoded at an encoder side or coded data associated with the current block to be decoded at a decoder side;
dividing the current block into N regions, wherein N is a positive integer;
deriving N motion vectors for the N regions respectively;
refining the N motion vectors to derive N best refined motion vectors; and
applying further motion vector refinement for the current block in a subsequent pass by using information comprising the N best refined motion vectors.

11. The method of claim 10, wherein the N regions correspond to N non-overlapped sub-search regions.

12. The method of claim 10, wherein the N regions correspond to N arbitrary-shaped regions.

13. The method of claim 10, wherein a target best refined motion vector is derived by searching around an initial motion vector in a target region of the N regions based on a minimum bilateral matching cost between two reference blocks in L0 and L1 reference pictures.

14. The method of claim 10, a candidate list including N best refined motion vectors of N regions is generated with similarity check to ensure that no best refined motion vectors in the candidate list are the same.

15. The method of claim 10, an index is signalled or parsed to indicate a target best refined motion vector in the candidate list, and further motion vector refinement is applied on the target best refined motion vector.

16. An apparatus for video coding, the apparatus comprising one or more electronics or processors arranged to:
receive input data associated with a current block, wherein the input data comprise pixel data for the current block to be encoded at an encoder side or coded data associated with the current block to be decoded at a decoder side;
divide the current block into N regions, wherein N is a positive integer;
derive N motion vectors for the N regions respectively;
refine the N motion vectors to derive N best refined motion vectors; and
apply further motion vector refinement for the current block in a subsequent pass by using information comprising the N best refined motion vectors.
